(19) United States
(12) Patent Application Publication
(10) Pub. No.: US 2011/0067582 A1
(43) Pub. Date: Mar. 24, 2011

(54) Soup and Sauce Grease Remover

(76) Inventor: Ottoniel Reyes, San Juan, PR (US)

(21) Appl. No.: 12/564,400

(22) Filed: Sep. 22, 2009

(51) Int. Cl. A47J 43/04

(52) U.S. Cl. 99/444

(57) ABSTRACT

A device, skimmer or utensil for removing unwanted fat, impurities or foam from excess starch accumulated on the surface of soups, stocks, sauces, stews, or boiling pasta; wherein the skimmer is slowly inserted into the cooked liquid and by gently rotating its handle back and forth and gradually dipping the plate into the liquid, the fat, grease, or unwanted foam is spilled onto its holding plate; thus, removing from the cooked food unhealthy fat and/or other unwanted impurities.

### CROSS-REFERENCE TO RELATED APPLICATION

N/A

### STATEMENT REGARDING FEDERALLY SPONSORED RESEARCH AND DEVELOPMENT

N/A

### BACKGROUND OF THE INVENTION

1. Field of the Invention

The present invention relates to a fat removal device, which quickly and simply, removes fat or grease accumulated on the surface of soups, stocks, sauces or stews without having to cool the mixture or remove it from its pot.

2. Discussion of the Background

It is well known that fats are part of our daily food. However, even when fats are used for several things, including but not limited to soap, this component is avoided for several reasons. For example, diets high in fat are linked to serious health problems and weight gain. Humanity is now indulged in a constant battle to limit fat consumption. Low calorie, low fat, or fat free foods are being marketed all around the planet for people who are fighting the battle with obesity. People are becoming more and more aware of the foods they consume. However, when meat, seafood, or poultry are one of the components of the foods that are being prepared, fat-free cooking is almost impossible. On the other hand, fat-free dishes can be tasteless and insipid.

As mentioned before fat is a natural component of the food such as meat, poultry, and other components that we use to cook soups, stews, sauces, etc. While cooking your food, these natural fats are released into your mixture. People use several methods to avoid consumption of this fat, which include using spoons to remove the layer of grease a bit at a time, or using an absorbent material such as bread, lettuce or even paper to slowly absorb the grease and remove it from the soup. Another method used to remove grease accumulated on the surface of a broth or soup is to cool the soup in the refrigerator overnight, which hardens the fat and then to scoop it up as a solid.

Therefore there is a need of a grease and/or fat remover capable of easily removing or controlling the amount of unwanted grease and/or fats from food such as meat, poultry, and other components that we use to cook soups, stews, sauces, etc.

### SUMMARY OF THE INVENTION

In light of the above shortcomings of the methods available to remove grease from soup, the present invention discloses a grease remover which removes layers of grease and/or fat in one quick and simple step by providing an easy to assemble device comprising a metal rod serving as a handle and a base plate, wherein said base plate is fixed to said rod by fixing means, such as a screw, wherein said fixing means are located between said base plate and said rod.

Another object of the present invention is to provide a device that is easy to assemble and disassemble for cleaning and storage purposes.

Another objective of the present invention is to provide a simple device and method for removing grease, fat or any other substance or fluid from a fluid inside a container.

Another object of the present invention is to provide a device that removes the grease and/or fats, wherein said device is placed inside a pot for skimming a layer of grease, fat or any fluid or substance on top of another liquid.

Another object of the present invention is to provide a device comprising of a rod attached to a plate which is tilted upwards at an angle.

Another object of the present invention is to provide a device comprising a structure that makes it easy to dispose of the removed grease or fat located at the base plate.

Yet another object of the present invention is to provide a device that controls the amount of fat or grease removed from a container.

To enable a better understanding of the objectives and features of the present invention, a brief description of the drawing below will be followed with a detailed description of the invention.

### BRIEF DESCRIPTION OF THE DRAWINGS

FIG. 1 is a plan view of the structure of the first preferred embodiment of the present invention.

FIG. 2 is a top view of the structure of the first preferred embodiment of the present invention.

FIG. 3 is an exploded drawing of the structure of the first preferred embodiment of the present invention.

FIG. 4 is a detail of the screw welded to the end of the plate and how it joins with the pipe or rod of the first preferred embodiment of the present invention.

FIG. 5 shows the first preferred embodiment completely assembled.

FIG. 6 is an isometric view of the structure of the first preferred embodiment of the present invention.

FIG. 7 is an isometric view of the structure of the first preferred embodiment of the present invention from a different angle.

FIG. 8 is a plan view of the structure of the pot size of the second preferred embodiment of the present invention.

FIG. 9 is a top view of the structure of the pot size of the second preferred embodiment of the present invention.

FIG. 10 is an exploded drawing of the structure of the pot size second preferred embodiment of the present invention.

FIG. 11 is a view of the small cone detail.

FIG. 12 is a view of the aluminum cross bar detail.

FIG. 13 is an isometric view of the structure of the pot size second preferred embodiment of the present invention.

FIG. 14 is an isometric view of the another preferred embodiment

FIG. 15 is a front view of the first embodiment of the grease remover with dispenser.

FIG. 16 is a front view of the handle of the first embodiment of the grease remover with dispenser.

FIG. 17 is a side view of the collecting plate.

FIG. 18 is a bottom view of the collecting plate.

FIG. 19 is a side view of the sealing plate.

FIG. 20 is a side view of the push rod.

FIG. 21 is a side view of the spring.

FIG. 22 is a front view of the second embodiment of the grease remover with dispenser.

FIG. 23 is a front view of the handle of the second embodiment of the grease remover with dispenser.

FIGS. 24a-b are detailed views of the twist rod and knob for the second embodiment of the grease remover with dispenser.

### DETAILED DESCRIPTION OF THE INVENTION

### Universal Grease Remover

The present invention discloses several preferred embodiments wherein each embodiment can be made of different materials, wherein the material selection depends on where the grease remover is operated, employed or used. For example, the material used includes but is not limit to heat resistant plastic, aluminum alloy or stainless steel. The devices are outfitted with a material that assists the handling of the device, such as rubber, located at handle H for an easy grip.

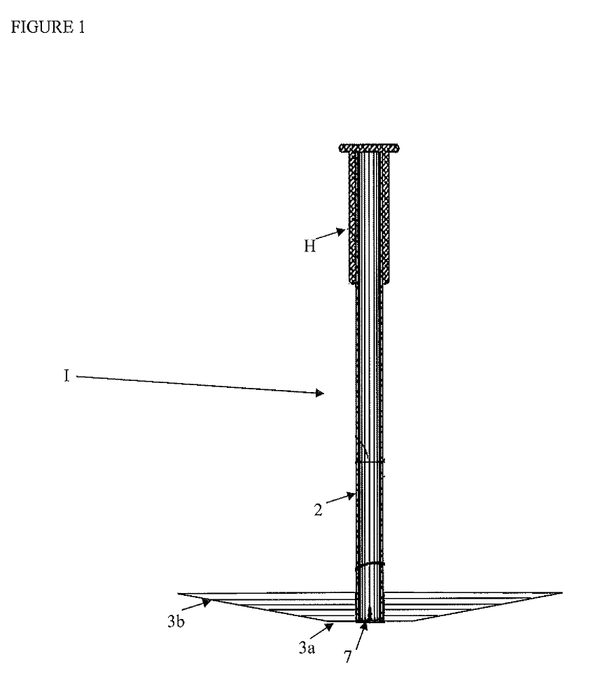

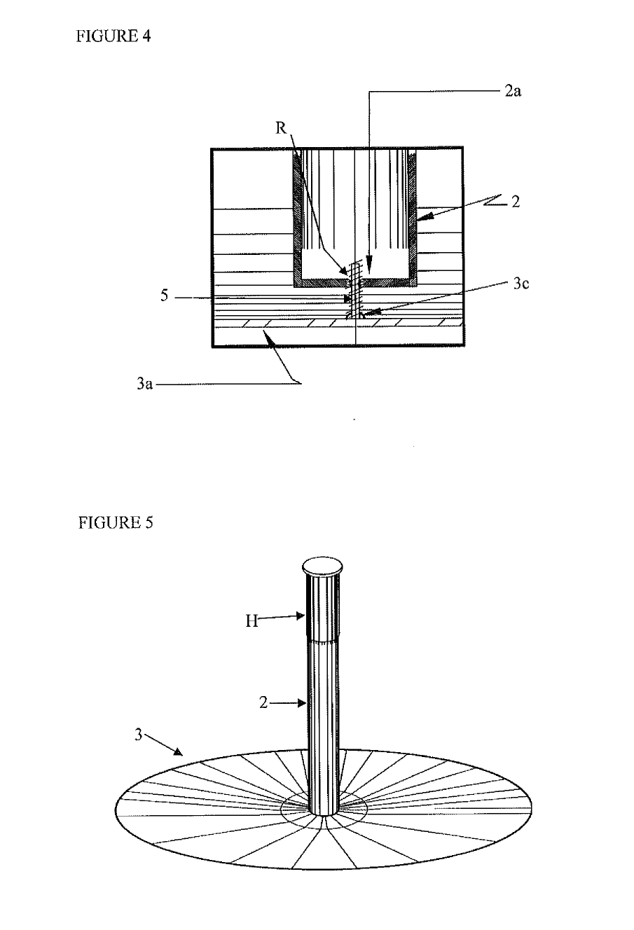

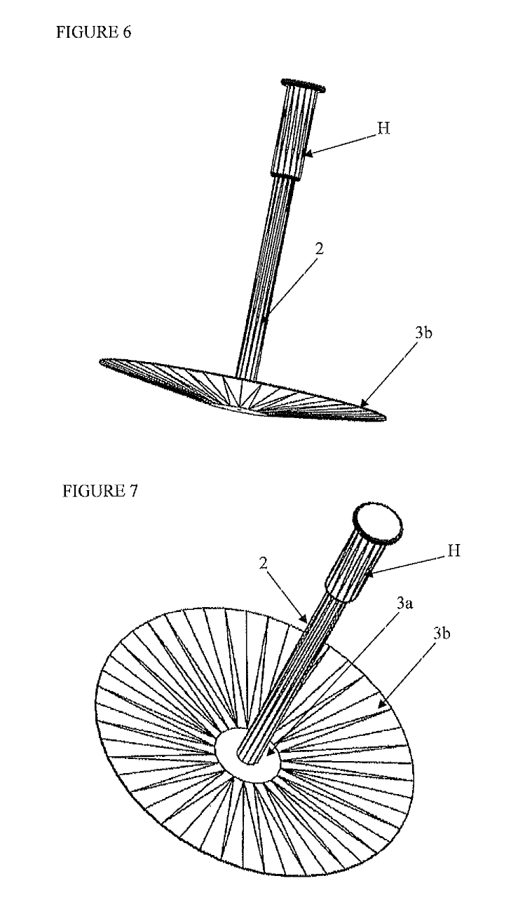

The first preferred embodiment I of the grease removal tool, as shown in FIGS. 1-7, is described and constructed as follows:

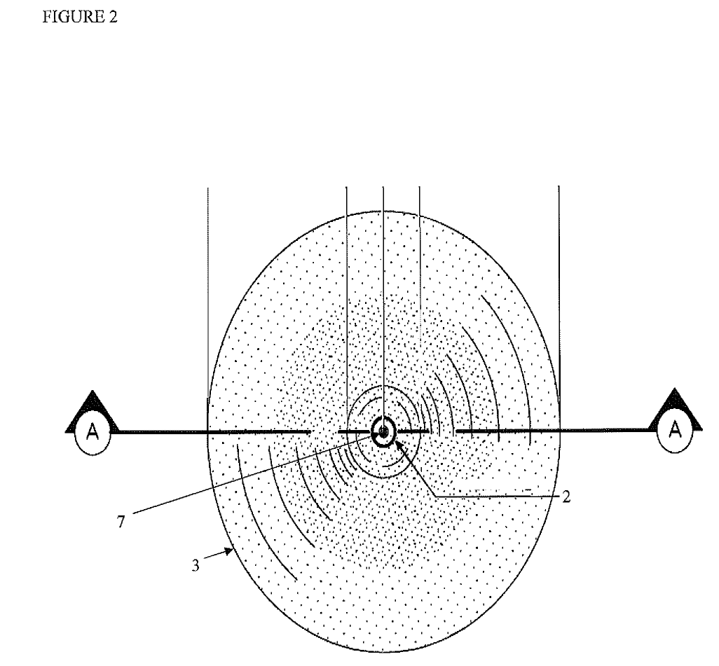

Referring to FIGS. 1 and 2 the grease skimmer comprises a round sheet or plate 3, a rod 2 and a handle H made from any of the materials mentioned before. The plate 3 can vary in diameter, however the selected diameter have to assist the device to keep a straight up position when the plate is located over flat surface.

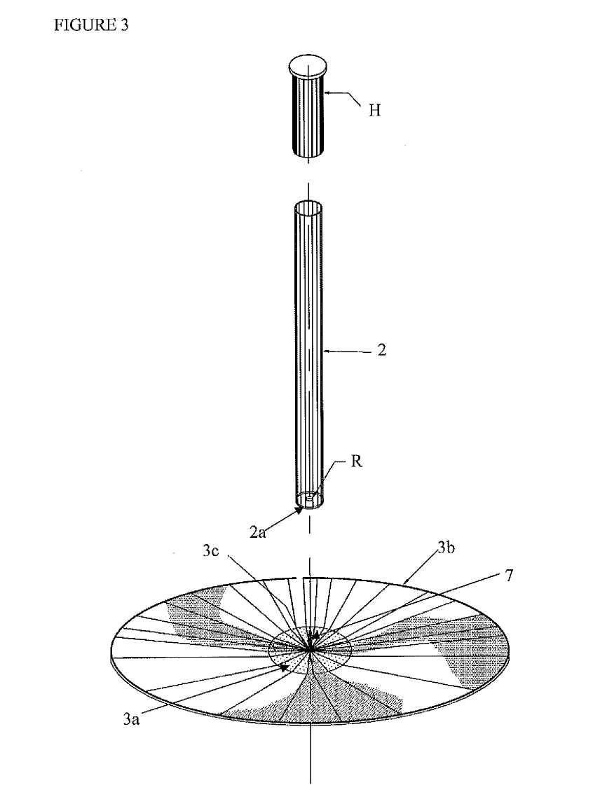

Referring to FIG. 3, a fixing mean, such as a screw 7 is welded 3c to the center of the plate 3a in order to fix said plate 3 to said rod 2.

Referring to FIG. 1, a radius from screw 7 is left as a flat surface 3a. From the edge 3b of that circumference, the plate will be tilted upwards at an angle, with the edges 3b of the plate ending up 1″ higher than the center 3a. It is important to understand that the 1 inch height is preferred to remain constant independently of the diameter of the plate 3.

The pipe or rod 2, as shown in FIG. 3, is fitted with a female internal thread R at center of tapping at bottom 2a of the pipe 2. This will then be screwed onto the screw 7 on the plate 3. Finally, a rubber heat insulator H with slip proof cup will be fitted onto the top of the pipe or rod 2 to act as a grip and to protect the user from the heat.

The device I will then serve as a simple, but useful tool for the quick and easy removal of grease, fat or oil sitting on top of another liquid, be it soup, sauce, stews, ground meat, etc. It will achieve this by following an easy two step process described below:

While firmly gripping the handle H, you place the base of the holding plate 3 on the surface of the liquid. Then the user begins to turn the handle H back and forth and slowly dips the strainer into the liquid until the fat accumulated on the surface begins to spill onto the plate. As the user continues to gradually submerge the strainer into the liquid, all the excess fat or grease collected on the surface will finish spilling onto the plate. At this point, the base liquid, be it soup, broth, sauce, etc. will begin to spill onto the plate. When this happens, slowly lift up the device and dispose of the fat and grease collected in the plate. The process can be repeated as necessary.

Pot Size Specific Grease Remover

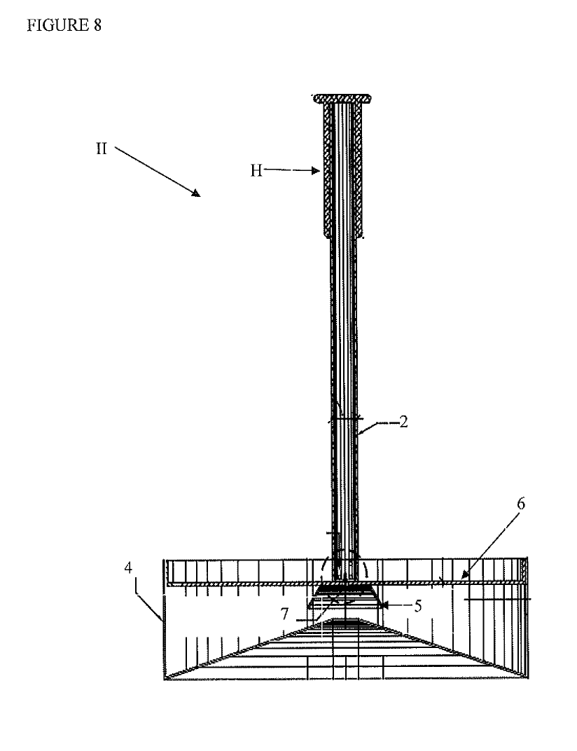

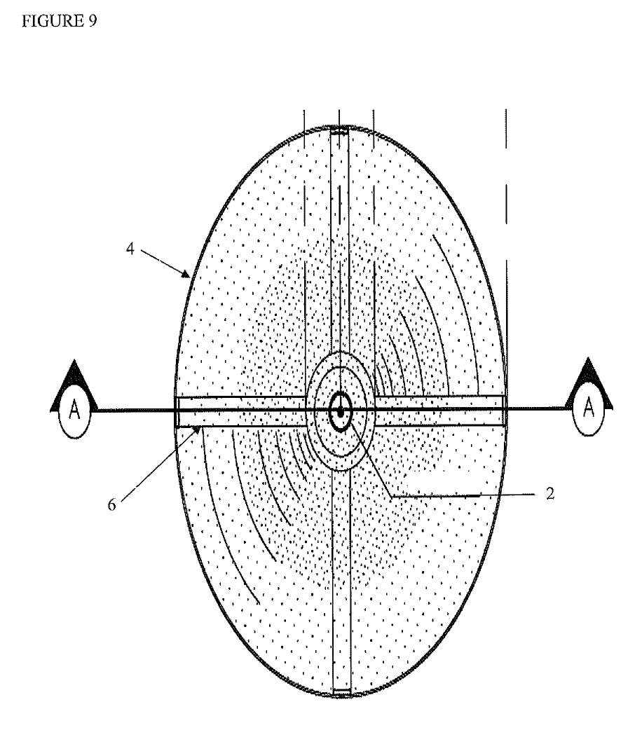

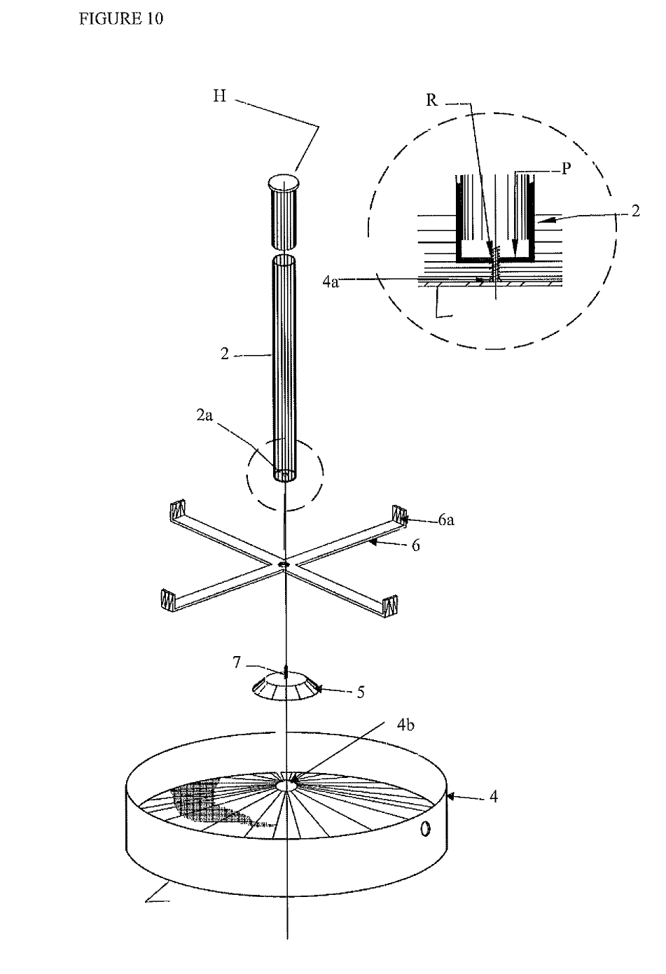

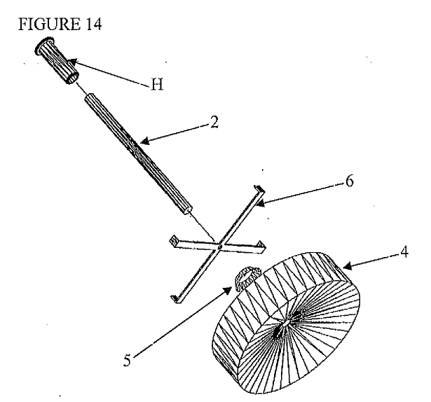

The second preferred embodiment II of the grease removal tool, as shown in FIGS. 8-14, is described and constructed as follows:

Referring to FIG. 8, the grease skimmer H comprises a round sheet or plate 4, a rod 2, a cone 5 and a handle H made from any of the materials mentioned. The plate 4 can vary in diameter; however the diameter is limited by the pot diameter wherein said second embodiment is fitted inside said pot. A hole 4b is cut into the center of the plate 4.

As opposed to the first preferred embodiment removal tool, in second embodiment of the present invention, the plate 4 angles downwards with the edges ending up lower than the center of the plate. A thin sheet is welded around the circumference of the plate 4, creating a container for the impurities to be removed. The two ends of the sheet are joined together by rivets.

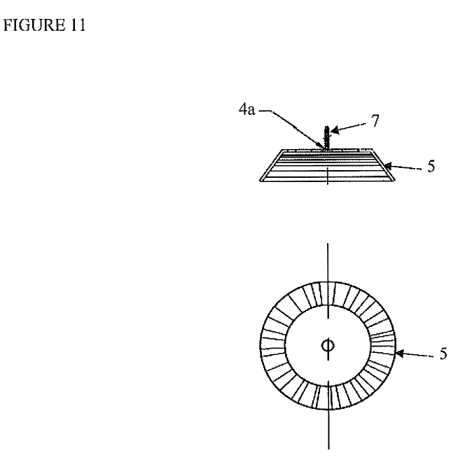

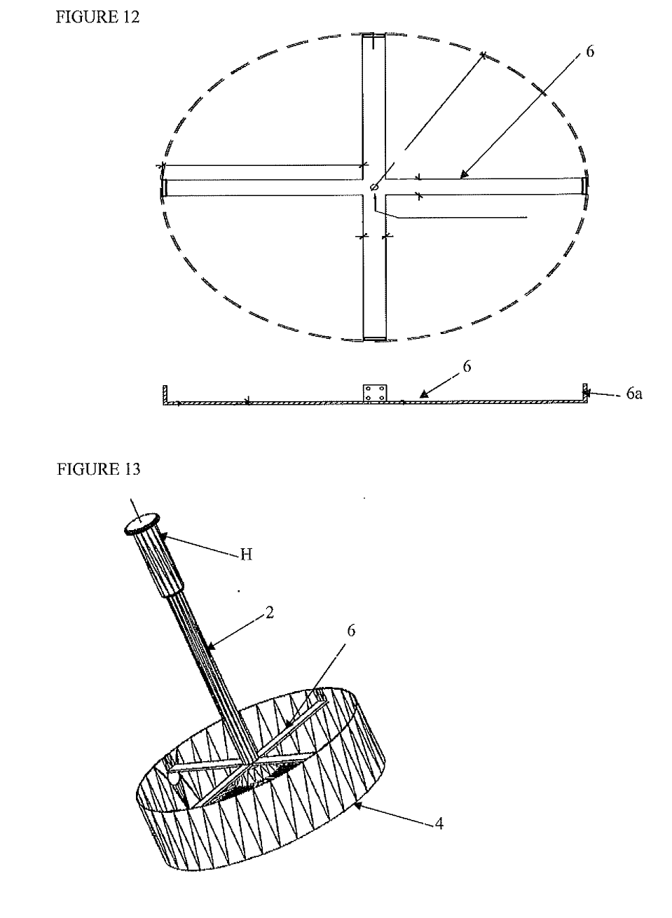

An aluminum cross bar 6, as shown in FIG. 12, is placed inside the holding plate 4 and riveted 6a to the topmost edge of the sheet welded to the bottom plate. A hole is drilled into the center of the cross bar 6. A small cone 5, as shown in FIG. 11, with a screw 7 welded to it is threaded through the hole in the crossbar 6 and screwed into a pipe 2 fitted with a female internal thread R at center of tapping 5.

This version of the grease remover uses pressure and fluid displacement principles to accomplish its purpose. It is designed to be used with specific size pots, so the edge of the tool or device and the edge of the pot are designed to be as close to each other as possible. As you lower the tool into the pot, the unwanted grease will accumulate in the center of the plate and will begin to spill into the holding container by the hole cut into the center of the plate.

Grease Remover with Dispenser

The third preferred embodiment 11 of the grease removal tool, as shown in FIGS. 15-24b, is described and constructed as follows:

The third preferred embodiment 11 of the present invention, as shown in FIG. 15, disclose a grease skimmer 11 comprising a handle 12, a collecting plate 13, a sealing plate 14, a push rod 15 and an insulator 10.

The handle 12 comprises a long cylinder attached to the center of the collecting plate 13. The collecting plate 13 comprises a dish-like structure with holes perforated at the bottom. The push rod 15 comprises a second long cylinder which will be inserted into the first long cylinder comprised by the handle 12. The push rod 15 is attached to the sealing plate 14, which comprises a flat circular surface that covers the holes at the bottom of the collecting plate 13. The entire assembly is held together by a spring.

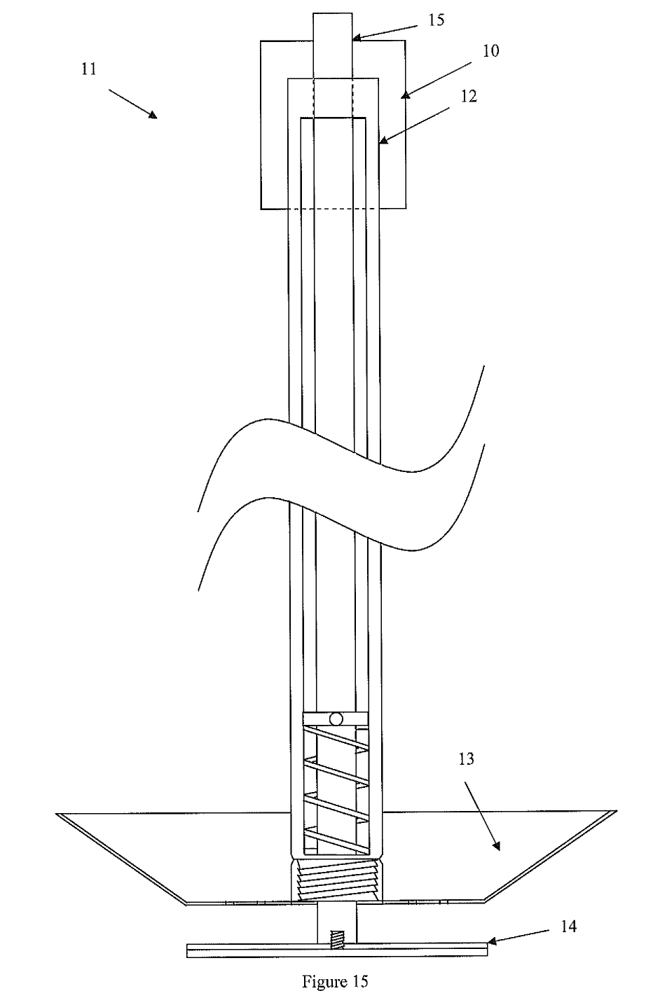

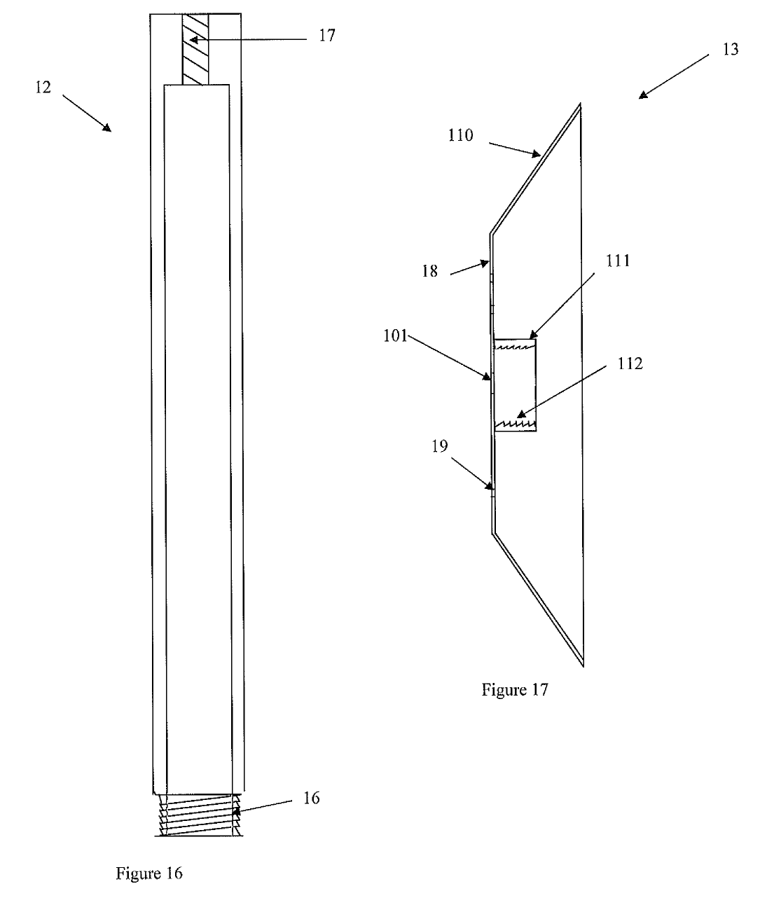

FIG. 16 shows the handle 12 separated from the assembly. The handle 12 comprises a hollow cylinder with two distinct ends. One end comprises a threaded outer surface 16, while the other opposite end comprises a reduced inner diameter 17.

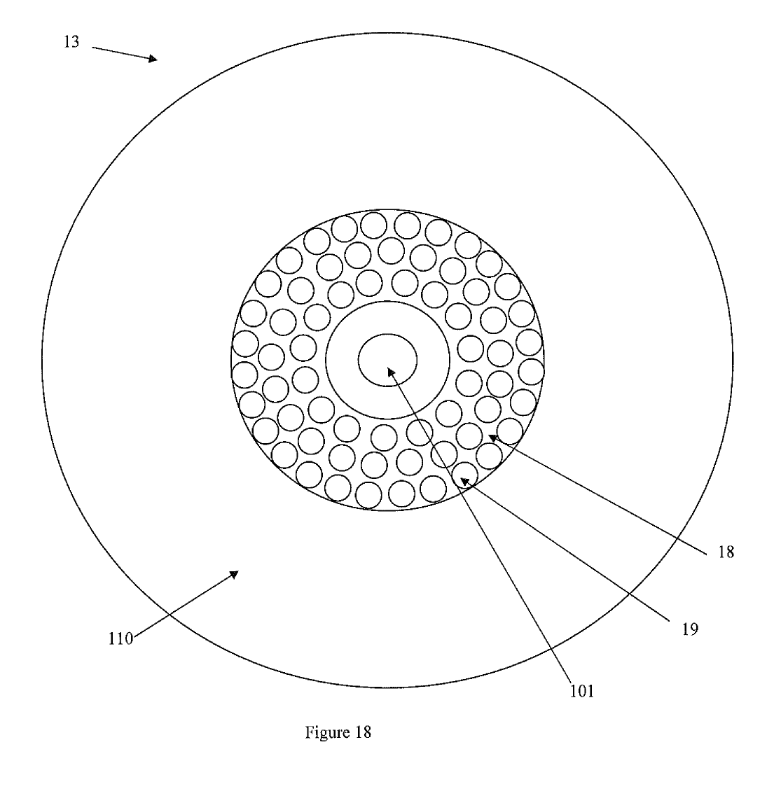

The collecting plate 13 is shown in FIGS. 17 and 18, wherein said collecting plate 13 comprises a flat, circular surface 18 with circular holes 19, an angled circular surface 110, and a cylinder 111 with a threaded inner surface 112. The flat circular surface 18 is attached concentrically to the angled circular surface 110 forming a bowl. The threaded cylinder 111 is attached concentrically to the flat circular surface 18 on the same side as the direction of the angled circular surface 110. That is, the threaded cylinder 111 is attached to the inner surface of the collecting plate 13. There is a hole 101 in the center of the flat surface 18, with a diameter greater than the diameter of the push rod 15 but less than the diameter of the inner thread 112.

The diameter and pitch of the threaded outer surface 16 of the handle 12 must be the same as the diameter and pitch of the threaded inner surface 112 of the cylinder 111 on the collecting plate 13, applying the appropriate tolerances for outer and inner threads. The handle 12 outer surface threads 16 and said collecting plate 13 inner surface threads 112 must fit together as male and female parts, respectively.

The holes 19 in the flat circular surface 18 are evenly distributed along the surface. The diameter of the holes 19 allow easy disposal of viscous fluids such as oil and grease.

The parts of the collecting plate 13 can be manufactured independently and fastened by welding, gluing or other methods. The holes 19 can be drilled or punched. The entire part can also be cast or molded as a single piece.

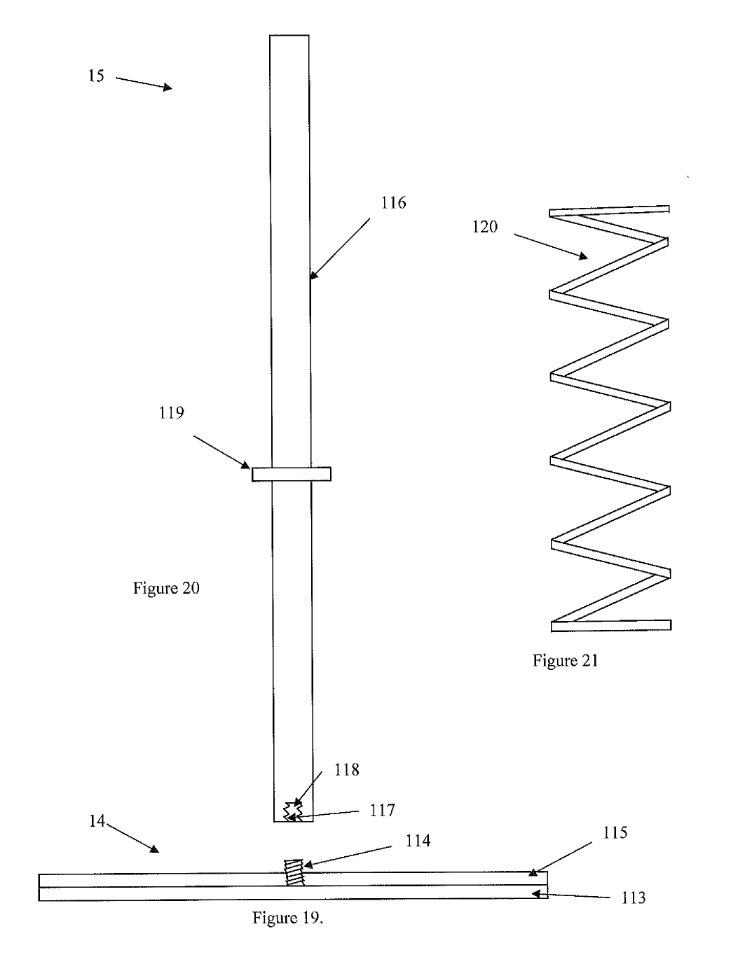

FIG. 19 shows the sealing plate 14, wherein said sealing plate comprises a flat circular surface 113 a threaded bolt 114, and a sealing pad 115. The threaded bolt 114 will be attached to the center of the sealing plate 14. The remaining surface of the sealing plate 14 not occupied by the threaded bolt 114 is covered with the sealing pad 115. The sealing pad 115 comprises a rubber or similar surface. The diameter of the sealing plate 14 must be equal to the diameter of the flat circular surface 18 of the collecting plate 13.

FIG. 20 shows the push rod 15, wherein said push rod 15 comprises a long cylinder 116 with a hollow end 117 with an inner thread 118 and a stopper 119. The stopper 119 comprises a thin cylindrical disk with a radius greater than the radius of the push rod 15 but less than the inner diameter of the handle 12. The length of the push rod 15 must be longer than the length of the handle 12. The diameter of the push rod 15 must be smaller than the diameter of the reduced inner diameter 17 of the end of the handle 12.

The diameter and pitch of the threaded outer surface of the bolt 114 of the sealing plate 14 must be the same as the diameter and pitch of the inner thread 118 of the push rod 15, applying the appropriate tolerances for outer and inner threads. The threaded outer surface of the bolt 114 and of the inner thread 118 of the push rod 15 must fit together as male and female parts, respectively.

FIG. 21 shows the spring 120. The spring 120 comprises a compression spring with a resistant force great enough to hold the parts into position and yet allow movement when a manual force is applied. The free length of the spring must be equal to or greater than the distance from the stopper 119 to the threaded end of the push rod 15. The compressed length of the spring 120 must be at least one inch less than the distance from the stopper 119 to the threaded end of the push rod 15. The inner diameter of the spring 120 must be greater than the outer diameter of the push rod 15. The outer diameter of the spring 120 must be less than the inner diameter of the handle 12.

The insulator 10 will comprise a hollow cylinder made from a material with low heat conductivity, such as plastic or rubber that will cover the exterior of the handle 12.

The parts will be assembled in the following order:

1. The push rod 15 is inserted into the inner diameter of the handle 12. The threaded end 118 of the push rod 15 is aligned with the threaded end 16 of the handle 12 by means of a hole 101 of the collecting plate 13. The other end of the push rod 15 is slide within the reduced inner diameter 17 of the handle 12.

2. The spring 120 is inserted into the space between the inner diameter of the handle 12 and the outer diameter of the push rod 15, coming into contact with the stopper 119.

3. The handle 12 is screwed onto the collecting plate 13 by means of the threaded inner surface 112 and threaded end 16. The spring 120 applies a force between the inner surface of the flat circular surface 18 within the cylinder 111 of the collecting plate and the stopper 119 of the push rod 15. The compressive force will push the stopper 119 towards the back end of the device 11, away from the collecting plate 13.

4. The threaded hollow end 118 of the push rod 15 is screwed onto the threaded bolt 114 of the sealing plate 14. To achieve this, the push rod 15 must be pushed forward by applying a force at the other end. The push rod 15 will slide through the hole 101 of the flat surface 18 of the collecting plate 13. When the push rod 15 is released, the spring 120 maintains the sealing plate 14 firmly in place adjacent to the collecting plate 13 by exerting a force on the stopper 119. The holes 19 of the collecting plate 13 are covered by the sealing plate 14. The sealing pad 115 ensures that the bowl created by the collecting plate 13 and the sealing plate 14 is watertight.

When assembled, the device serves as a simple, but useful tool for the quick and easy removal of grease, fat or oil sitting on top of another liquid, be it soup, sauce, stews, pastas, etc.

To use the device, the base of the collecting plate is placed above the surface of the liquid, with the sealing plate 14 parallel to said surface. Then the device 11 is pushed into the surface of the liquid slowly and with a slight back and forth rotation about the longitudinal axis of the device 11. Due to the device structure and mentioned motion the fat accumulated on the surface of the liquid begins to spill into the collecting plate 13. As the user continues to gradually submerge the device 11 into the pot's liquid, all the excesses of fat and/or grease located at the surface spills into the collecting plate 13. The fat, due to its density, is usually found on the uppermost layer of the pot. Therefore, the spilling of liquids that are not wanted to be removed into the collecting plate 13 is an indication that a small amount or non-unwanted liquids remain in the pot. At this point, the device 11 can be removed from the liquid by lifting vertically.

To dispose of the unwanted liquid, such as fat or grease, the sealing plate 14 must be separated from the collecting plate 13 because the holes 19 for draining the unwanted liquid are covered by said sealing plate 14. To separate the sealing plate 14 from the collecting plate 13, the end of the push rod 15 must be pushed into the handle 12. The sealing plate 14, rigidly fastened to the push rod 15, will separate from the collecting plate 13.

The process is repeated, if necessary. Further when necessary the device is disassembled for easy cleaning.

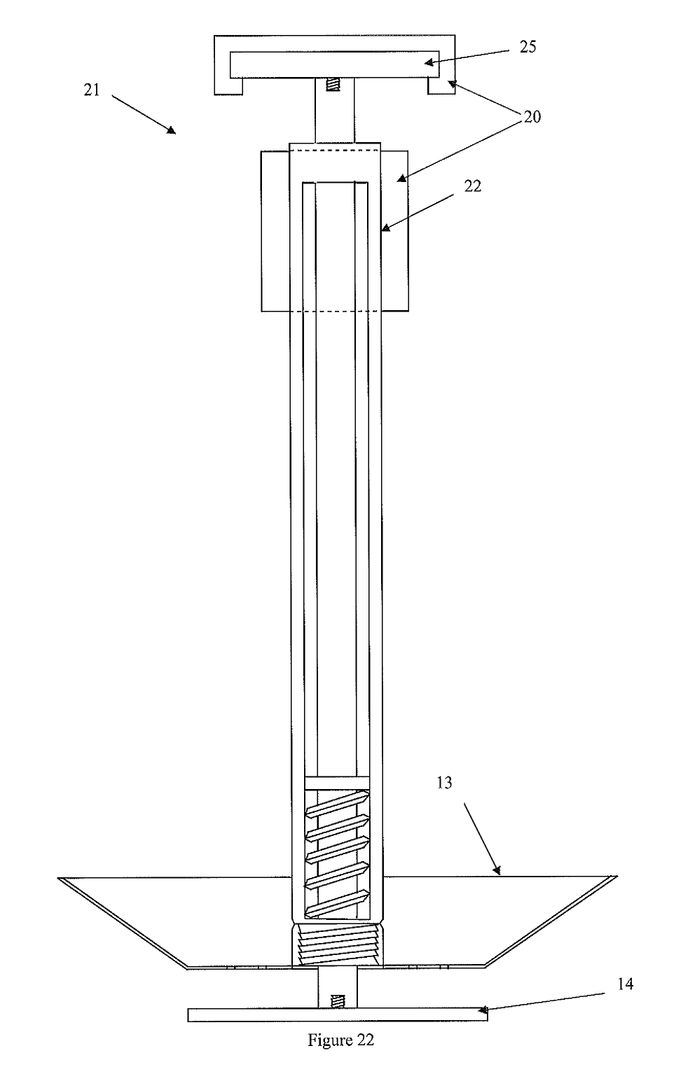

The fourth embodiment of the invention is shown in FIG. 22. The grease skimmer 21 comprises a handle 22, a collecting plate 13, a sealing plate 14, a twist rod 25 and an insulator 20.

The handle 22 comprises a long cylinder which is attached to the center of the collecting plate 13. The collecting plate 13 comprises a dish-like structure with holes perforated at the bottom. The twist rod 25 comprises a second long cylinder which will be inserted into the first long cylinder comprised by the handle 22. The twist rod 25 is attached to the sealing plate 14, which comprises a flat circular surface that will cover the holes at the bottom of the collecting plate 13. The entire assembly is held together by threads located on the inner surface of the handle 22 and the outer surface of the twist rod 25.

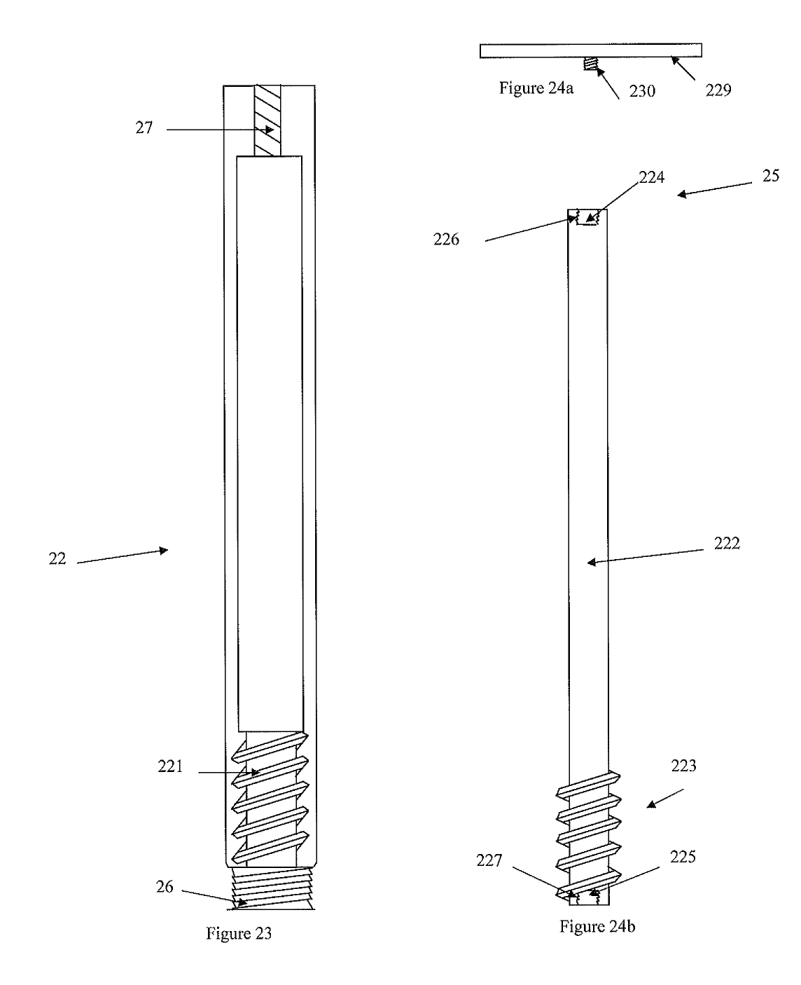

FIG. 23 shows the handle 22 separated from the assembly. The handle 22 comprises a hollow cylinder with two distinct ends. One end comprises a threaded outer surface 26 and a threaded inner surface 221. The opposite end comprises a reduced inner diameter 27.

The embodiment of the invention here described comprises the collecting plate 13 and sealing plate 14 as used in the previous embodiments, assembled in the same manner.

FIGS. 24a-24b show the twist rod 25. The twist rod 25 comprises a long cylinder 222 with a threaded outer surface 223, two hollow ends 224, 225 with inner threads 226, 227 and a knob 229 with a threaded bolt 230. The length of the push rod 25 must be longer than the length of the handle 22. The diameter of the push rod 25 must be smaller than the diameter of the reduced inner diameter 27 of the end of the handle 22.

The diameter and pitch of the threaded outer surface 223 of the twist rod 25 must be the same as the diameter and pitch of the inner thread 221 of the handle 22, applying the appropriate tolerances for outer and inner threads. The inner thread 221 of the handle 22 and the threaded outer surface 223 of the twist rod 25 must fit together as male and female parts, respectively. The pitch of the inner thread 221 of the handle 22 and the threaded outer surface 223 of the twist rod 25 must be designed such that a few turns of the twist rod 25 within the handle 22 are needed to obtain a significant linear motion of the twist rod 25.

The diameter and pitch of the threaded bolt 230 of the knob 229 must be the same as the diameter and pitch of the threaded inner surface 226 of the cylinder 222 on the twist rod 25, applying the appropriate tolerances for outer and inner threads. The threaded bolt 230 of the knob 229 and the threaded inner surface 226 of the cylinder 222 must fit together as male and female parts, respectively.

The diameter and pitch of the threaded outer surface of the bolt 114 of the sealing plate 14 must be the same as the diameter and pitch of the inner thread 227 of the push rod 25, applying the appropriate tolerances for outer and inner threads. The two threads 114, 227 must fit together as male and female parts, respectively.

The insulator 10 will comprise a hollow cylinder made from a material with low heat conductivity, such as plastic or rubber that will cover the exterior of the handle 22 and the knob 229.

The parts will be assembled in the following order:

1. The cylinder 222 of the twist rod 25 will be screwed into the inner diameter of the handle 22. The threaded end 225 of the push rod 25 will be aligned with the threaded end 26 of the handle 22.

2. The bolt 230 of the knob 229 will be screwed into the hollow end 224 of the cylinder 222.

3. The handle 22 will be screwed onto the collecting plate 13.

4. The threaded hollow end 225 of the push rod 25 will be screwed onto the threaded bolt 114 of the sealing plate 14. To achieve this, the twist rod 25 must be twisted clockwise with respect to the handle 22. The twist rod 25 will slide through the hole 101 of the flat surface 18 of the collecting plate 13. When the twist rod 25 is twisted counter-clockwise, the holes 19 of the collecting plate 13 will be covered by the sealing plate 14. The sealing pad 115 will ensure that the bowl created by the collecting plate 13 and the sealing plate 14 is watertight.

When assembled, the device will then serve as a simple, but useful tool for the quick and easy removal of grease, fat or oil sitting on top of another liquid, be it soup, sauce, stews, pastas, etc.

The device is used in the same manner as the previous embodiments. To dispose of the unwanted liquids, the sealing plate 14 must be separated from the collecting plate 13. The liquid will drain through the holes 19. To separate the sealing plate 14 from the collecting plate 13, the end of the twist rod 25 must be rotated in a clockwise direction. The threads 221, 223 will incite a linear motion of the twist rod 25 into the handle 22. The sealing plate 14, rigidly fastened to the push rod 25, will separate from the collecting plate 13.

The process can be repeated, if necessary. The device can be disassembled for easy cleaning.

In summary of the previous sections, the invention presented here is structurally innovative, presents advantages not available at the moment with existing culinary utensils, complies with all new patent application requirements and is hereby lawfully submitted to the patent bureau for review and the granting of the commensurate patent rights.

While the invention has been described as having a preferred design, it is understood that many changes, modifications, variations and other uses and applications of the subject invention will, however, become apparent to those skilled in the art without materially departing from the novel teachings and advantages of this invention after considering this specification together with the accompanying drawings. Accordingly, all such changes, modifications, variations and other uses and applications which do not depart from the spirit and scope of the invention are deemed to be covered by this invention as defined in the following claims and their legal equivalents. In the claims, means-plus-function clauses, if any, are intended to cover the structures described herein as performing the recited function and not only structural equivalents but also equivalent structures.

All of the patents, patent applications, and publications recited herein, and in the Declaration attached hereto, if any, are hereby incorporated by reference as if set forth in their entirety herein. All, or substantially all, the components disclosed in such patents may be used in the embodiments of the present invention, as well as equivalents thereof. The details in the patents, patent applications, and publications incorporated by reference herein may be considered to be incorporable at applicant's option, into the claims during prosecution as further limitations in the claims to patentable distinguish any amended claims from any applied prior art.

1. A fluid remover comprising;
a collecting plate, wherein said collecting plate comprises an angled surface and a flat center portion, wherein said flat center portion comprises fixing means, draining means and a center hole;
a handle, wherein said handle comprises a cylindrical hollow body with a first distal end and a second distal;
wherein said second distal end comprises attaching means,
wherein said fixing means connects said attaching means fixing said handle to said collecting plate;
and a disposing fluid mechanism, wherein said disposing mechanism comprises a sealing plate and an actuator sealing plate.

2. A fluid remover as in claim 1, wherein said handle is surrounded by an insulation material.

3. A fluid remover as in claim 1, wherein the flat center portion has a circular shape, wherein said center hole is located at the center of said flat center and said attaching means surround the center hole and said drain means surrounds the center hole and the attaching means,
wherein said circular flat surface perimeter is connected to the angled surface,
wherein said angled surface has a conical shape.

4. A fluid remover as in claim 1, wherein said first distal end comprises an reduced inner diameter; and
wherein said actuator sealing plate comprises a push rod and a resilient material,
wherein said resilient material fits inside said cylindrical hollow body and contacts the push rod controlling said push rod displacement,
wherein said push rod comprises a cylindrical body having a first extreme, a second extreme and a support, wherein said second extreme comprises connecting means,
wherein said connecting means fixes said sealing plate to said cylindrical body and wherein said cylindrical body first extreme is slide though said reduced inner diameter.

5. A fluid remover as in claim 1, wherein said first distal end comprises an reduced inner diameter and wherein said second distal end has a motion displacement path; and
wherein said actuator sealing plate comprises a twist rod and a knob,
wherein said twist rod comprises a cylindrical body having a first extreme, a second extreme and a support, wherein said second extreme comprises connecting means and a motion converted structure,
wherein said motion converted structure fits inside said cylindrical hollow body and is mechanically coupled to the motion displacement path to assists the twist rod displacement,
wherein said connecting means fixes said sealing plate to said cylindrical body second extreme and wherein said cylindrical body first extreme is slide through said reduced inner diameter and said knob is fixed to said cylindrical body first extreme.

6. A fluid remover as in claim 1, wherein said motion converted structure comprises first threaded surface and said motion displacement path comprises a second threaded surface.

7. A fluid remover as in claim 1, wherein said sealing plate mechanically contacts said draining means.

8. A fluid remover as in claim 1, wherein said fixing means comprises a male threaded surface and said attaching means comprises a female threaded surface.
